(19) United States
(12) Patent Application Publication
(10) Pub. No.: US 2003/0132702 A1
(43) Pub. Date: Jul. 17, 2003

(54) Passivating organic light emitting devices

(76) Inventors: Ponnusamy Palanisamy, Lansdale, PA (US); James R. Demarco, Howell, NJ (US)

Correspondence Address: Timothy N. Trop, TROP, PRUNER & HU, P.C., STE 100, 8554 KATY FWY, HOUSTON, TX, 77024-1805, US

(21) Appl. No.: 10/354,298

(22) Filed: Jan. 30, 2003

Related U.S. Application Data
(62) Division of application No. 09/904,407, filed on Jul. 12, 2001.

(51) Int. Cl. H01J 63/04

(52) U.S. Cl. 313/504

(57) ABSTRACT

Organic light emitting material may be effectively passivated in organic light emitting device display manufacture by selectively applying an organic passivation material to the recently deposited organic light emitting material. By a selective deposition process, other areas of the display need not be immediately passivated. As a result, contact areas (and other areas which should not be passivated) may remain unpassivated during the manufacturing process. By using organic passivity materials, incompatibilities between the organic light material and the passivation material may be reduced. In many cases, it may be desirable to limit the temperatures that are applied during the curing process. In one embodiment, ultraviolet curing may be utilized.

### BACKGROUND

This invention relates generally to organic light emitting device displays.

Organic light emitting devices use an organic or polymer material that emits light for displays in electronic devices. An organic material that is light emissive may be sandwiched between row and column electrodes. When a potential is applied to the light emitting material, it emits light of a particular wavelength. The emitted light passes through the column electrode which may be transparent in some embodiments. Organic light emitting devices offer the potential for relatively low cost displays made from organic light emitting material.

One problem with organic light emitting materials is that they are relatively sensitive to moisture, oxygen and common solvents. Thus, even during the manufacturing process, the organic light emitting materials may be attacked by moisture and oxygen in the surrounding atmosphere and solvents used in the remaining portions of the manufacturing process.

The conventional solution to this problem is to passivate the organic light emitting materials. However, passivating them quickly after they are deposited creates new problems. Particularly, if the organic light emitting material is immediately passivated after deposition, the passivation may obstruct the remainder of the manufacturing process. For example, the deposition of passivation material may obstruct contact pads as one example. Thus, additional process steps may be needed to remove passivation that was formed early in the process.

Another problem is that the organic light emitting materials are not totally compatible with conventional passivation materials. Common passivation materials are inorganic materials such as silicon nitride, phosphosilicate glass and silicon carbide. Still another problem is that many of these common passivation materials require deposition temperatures that exceed the temperatures at which organic light emitting materials may be properly processed.

Thus, there is a substantial need to promptly passivate organic light emitting materials after deposition. But doing so may create a range of problems. Thus, there is a need for a way to enable organic light emitting materials to be effectively passivated.

### BRIEF DESCRIPTION OF THE DRAWINGS

FIG. 1 is a cross-sectional view of an organic light emitting display in accordance with one embodiment of the present invention;

FIG. 2 is a partial, enlarged cross-sectional view taken generally along the line 2-2 in FIG. 1;

FIG. 3 is a schematic depiction of one embodiment of the present invention;

FIG. 4 is a schematic depiction of another embodiment of the present invention;

FIG. 5 is a schematic depiction of another embodiment of the present invention; and

FIG. 6 is a depiction of the results of the process shown in FIG. 5 in accordance with one embodiment of the present invention.

### DETAILED DESCRIPTION

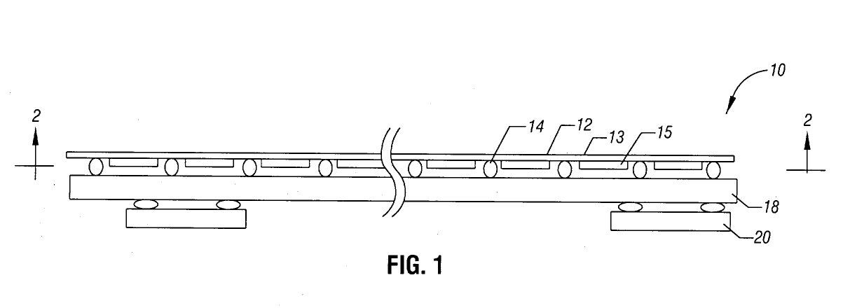

Referring to FIG. 1, an organic light emitting device (OLED) display 10 may, in one embodiment, include a two-part system. One part is the display panel 12, which includes a display glass 13 and tri-pixels 15 deposited thereon. The tri-pixels 15 may include organic light emitting material that emits light of a wavelength corresponding to each of three colors of a tri-color color space. Also associated with the display panel 12 may be row and column electrodes.

The second component includes a circuit board 18 that interacts both with the display panel 12 and with driver integrated circuits 20. The driver integrated circuits 20 provide signals to control the operation of the tri-pixels 15. These signals are distributed by the circuit board 18 to the appropriate tri-pixels 15.

The display panel 12, the circuit board 18 and the integrated circuit devices 20 may all be coupled by surface mount technology in one embodiment. The surface mount technology may include the use of solder balls or bumps 14 that are reflowed to join the various components together.

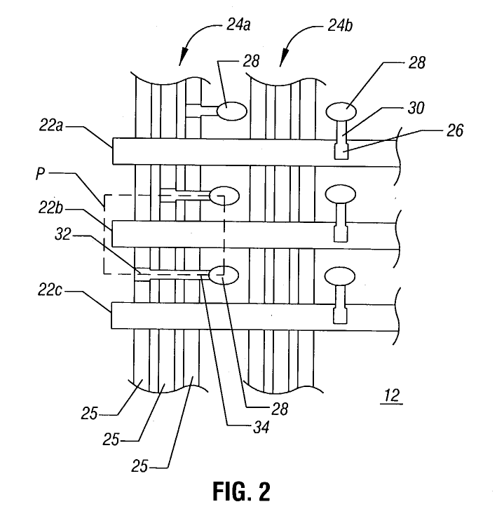

Referring to FIG. 2, the display panel 12 may include contact pads 28 that contact the solder balls or bumps 14. The contact pads 28 may, in turn, make an electrical connection through a metallization 34 to a contact 32. The contact 32, in turn, may couple a pad 28 to a row electrode 25.

In FIG. 2, a set of three column electrodes 25 may be associated with each pixel P. One column electrode 25 may be utilized for each of the three colors of each pixel P in one embodiment.

At the same time, the row electrodes 22 may be contacted by contacts 26 coupled by metallizations 30 to contact pads 28. The contact pads 28 coupled to the metallizations 30 are also coupled to solder balls or bumps 14. However, the metallizations 30 couple the contact pads 28 to the row electrodes 22a which may extend generally transversely to the column electrodes 25. In each case, the contacts 28 may reside in a gap between adjacent column electrodes 25.

In some cases, the row electrodes 22 may be formed of metal such as aluminum while the column electrodes 25 may be formed of a transparent material such as indium tin oxide (ITO). Sandwiched between the column and row electrodes 25 and 22 is the organic light emitting material. Generally, an entire row of pixels is activated at a single time and then the particular columns are selectively activated to create light of the desired brightness and appropriate calibration values.

Thus, it can be seen that the contacts 28 are in very close proximity to the pixels P. The pixels P include the organic light emitting material which advantageously may be promptly passivated. Because of the tendency of many organic light emitting materials to be attacked by moisture, oxygen or solvents, it may be desirable to passivate the organic light emitting material as soon as possible. However doing so early in the fabrication process may also result in the imposition of passivation materials in areas in which the passivation material may be detrimental. For example, if the structure shown in FIG. 2 were passivated, the contacts 28 would also be obscured and rendered ineffective by passivation. This would necessitate additional processes to remove the passivation from the contacts 28.

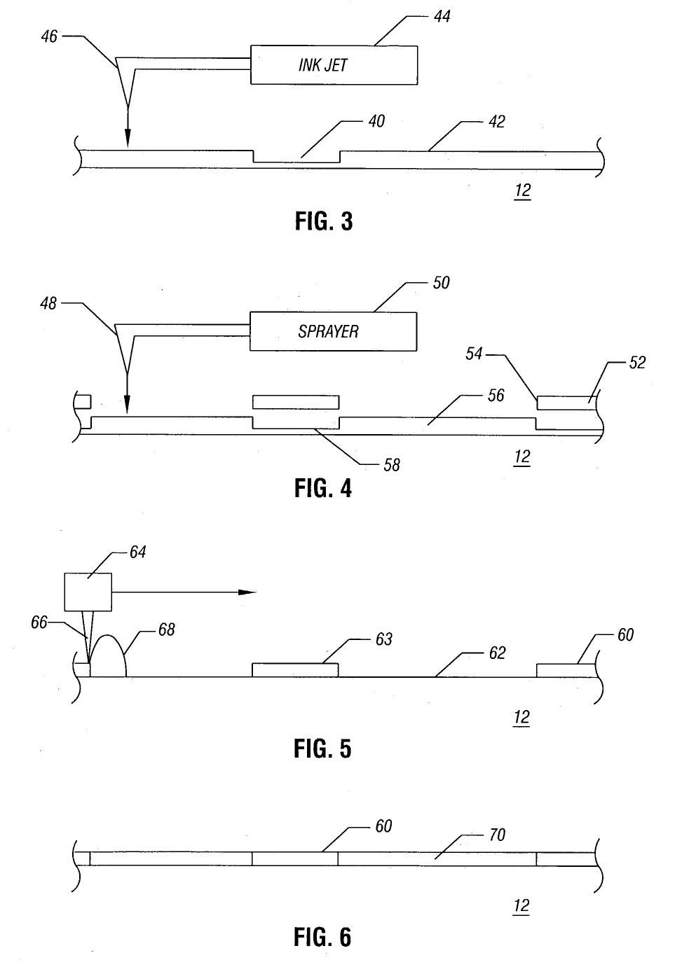

To overcome these and other problems, the passivation may be selectively applied. In other words, the passivation may be selectively applied to the areas coated by the OLED while excluding areas where passivation would be undesirable, such as the areas proximate to the contacts 28. One selective, passivation deposition technique, shown in FIG. 3, involves an ink jet printer 44 to selectively apply passivation to areas 42 while leaving areas 40 over the display panel 20 uncovered. The ink jet printer 44 is capable of applying the passivation material through a nozzle 46 at a very high rate. In this way, passivation may be selectively applied.

In accordance with another technique, a passivation sprayer 50 may be utilized to spray passivation 48 over the display panel 12, as shown in FIG. 4. A mask 52 with openings 54 may be utilized to define the regions where passivation may be applied and where it should not be applied. For example, passivation may be applied, as indicated at 56, and no passivation may provided at the areas 58, in one example.

In the spraying technique, an organic epoxy-based passivation material that has good moisture and solvent barrier may be applied by spraying through the mask 52. The passivation is applied where needed leaving electrical contact areas uncoated. Advantageously, ultraviolet curable materials may be utilized. However, heat curable materials may also be utilized if excessive heat (which would damage the organic light emitting material) is not necessary.

Turning next to FIG. 5, a screen printing technique may be utilized to passivate selectively. In this case, a screen 60 is applied over the display panel 20. A squeegee 64 is passed across the surface of the screen 60 causing the material 68 to be pressed into the regions where the screen 60 is open and excluded from the regions where the screen 60 is not opened. Thus, the material 68 may be applied in the region 62 and excluded from the region 63. The squeegee 64 may include a squeegee blade 66 in one embodiment. Thus, as shown in FIG. 6, the screen printed passivation 70 ends up in the region 62 and not in the region 60.

With screen printing processes, a range of passivation material viscosities may be utilized. Also, a screen printing process, with rapid ultraviolet curing at room temperature, makes for a very fast, low temperature, in-line manufacturing process in one embodiment. The rapid processing time also limits the exposure of the organic light emitting material to air where moisture absorption can occur. The screen printing process is amenable to both liquid and paste passivation materials.

Paste compositions, including both organic and inorganic materials, may be tailored to achieve desirable characteristics in the cured state, including higher resistance to moisture penetration, improved thermal conductivity, and thermal expansion better matched to the substrate.

In general, by using organic materials, the incompatibilities between the organic light emitting material and the organic passivation material may be reduced. One particularly advantageous organic passivation material is the Norland UV Sealant 91 available from Norland Products, Inc., Cranbury, N.J., 08512. This material is a screenable paste adhesive that cures quickly at room temperature when exposed to ultraviolet light. It absorbs less than 0.14% of water in 24 hours at 50° C. Generally, a high intensity ultraviolet light source may be utilized to cure the material in 5 to 10 seconds using a 1,000 watt or 1,500 watt medium pressure mercury lamp at 4 to 6 inches. Of course, other materials may be utilized as well.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a display panel including an organic light emitting material;
selectively applying an organic passivation material over said organic light emitting material while excluding said passivation material from other areas of said display panel; and
curing said passivation material.

2. The method of claim 1 wherein selectively applying includes ink jet printing an organic passivation material.

3. The method of claim 1 wherein selectively applying includes spraying an organic passivation material through a mask.

4. The method of claim 1 wherein selectively applying includes screen printing an organic passivation material.

5. The method of claim 1 wherein curing said passivation material includes using ultraviolet radiation to cure said passivation material.

6. The method of claim 1 including selectively applying the organic passivation material on the organic light emitting material while excluding the passivation material from contact areas.

7. The method of claim 1 including passivating said organic light emitting material before the fabrication of said display panel is complete.

8. The method of claim 1 including coupling said display panel to a circuit board.

9. The method of claim 8 including surface mount connecting said display panel to said circuit board.

10. The method of claim 9 including electrically coupling said display panel to said circuit board through contacts that were excluded from the application of passivation material.

11. A method comprising:
depositing an organic light emitting material on a panel;
forming contact pads on said panel;
selectively applying a passivation material over said organic light emitting material while excluding said passivation material from said contact pads;
curing said passivation material; and
electrically coupling said panel to another surface.

12. The method of claim 1 wherein selectively applying passivation material includes selectively applying organic passivation material at a temperature that does not adversely effect said organic light emitting material.

13. The method of claim 11 wherein selectively applying includes ink jet printing an organic passivation material.

14. The method of claim 11 wherein selectively applying includes spraying an organic passivation material through a mask.

15. The method of claim 11 wherein selectively applying includes screen printing an organic passivation material.

16. The method of claim 1 wherein curing said passivation material includes using ultraviolet radiation to cure said passivation material.

17. The method of claim 11 wherein electrically coupling includes coupling said panel to a circuit board.

18. The method of claim 17 including surface mount connecting said panel to said circuit board.

19. The method of claim 18 including electrically coupling said panel to said circuit board through contacts that were excluded from the application of passivation material.

20. A display panel comprising:
a substrate;
an organic light emitting material deposited on said substrate;
a plurality of contact pads electrically coupled to said light emitting material; and
an organic passivation material over said organic light emitting material while exposing said contact pads.

21. The display panel of claim 20 wherein said contact pads are surface mount contact pads.

22. The display panel of claim 20 wherein said passivation material is organic ultraviolet curable material.

23. The display panel of claim 22 wherein said passivation material is an adhesive.
